(19) United States
(12) Patent Application Publication
(10) Pub. No.: US 2012/0200757 A1
(43) Pub. Date: Aug. 9, 2012

(54) IMAGING DEVICE AND CONTROL METHOD THEREOF

(75) Inventor: Hideaki Kasahara, Moriguchi-shi (JP)

(73) Assignee: SANYO ELECTRIC CO., LTD., Osaka (JP)

(21) Appl. No.: 13/364,581

(22) Filed: Feb. 2, 2012

(30) Foreign Application Priority Data
Feb. 4, 2011 (JP) 2011-022392

(51) Int. Cl. H04N 5/225

(52) U.S. Cl. 348/333.01; 348/E05.024

(57) ABSTRACT

An imaging device includes an imaging unit and a display unit. The display unit successively displays each of two or more images of images captured by the imaging unit and images cut out in one or more modes from the captured images.

This nonprovisional application is based on Japanese Patent Application No. 2011-022392 filed on Feb. 4, 2011 with the Japan Patent Office, the entire contents of which are hereby incorporated by reference.

### BACKGROUND OF THE INVENTION

1. Field of the Invention

The present invention relates to an imaging device, and particularly to an imaging device capable of cutting out images in a plurality of modes from a captured image, as well as a control method for the imaging device.

2. Description of the Related Art

There have been imaging devices such as digital camera and digital video camera having the capability of recording both moving images and still images.

In such imaging devices capable of recording moving images and still images, an image sensor such as CCD (Charge Coupled Device) has a light receiving area in which an effective area is used for recording. Generally, the effective area for moving images and the effective area for still images are different from each other. Specifically, the effective area for moving images is generally smaller than the effective are for still images. Here, “effective area” refers to an area whose image is cut out from the light receiving area of the image sensor.

One of the reasons for the aforementioned different effective areas is that, when a moving image is to be recorded, signal charge generated in the image sensor has to be read in a shorter time as compared with still images. When a still image is to be recorded, it is only necessary to read the above-described signal charge at the timing when the release button of the imaging device is operated. In contrast, when a moving image is to be recorded, the above-described signal charge has to be read for example at intervals of approximately 1/30 second for the VGA (Video Graphics Array) size or approximately 1/15 second for the UXGA (Ultra eXtended Graphics Array) size.

Another reason is relevant to the capability of image stabilization performed on an image to be recorded. There are various techniques for image stabilization such as high-sensitivity-based image stabilization, electronic image stabilization, lens-shift image stabilization, and image-sensor(imaging element)-shift image stabilization. Particularly in the case where the electronic image stabilization is employed, image stabilization is carried out in which included shifting of an area to be used as the effective area in the light receiving area, and thus the effective area for moving images is smaller than that for still images.

When the conventional imaging device is in the camera mode, it displays a through image for one recording mode (moving image or still image) of a plurality of recording modes which are different from each other in terms of the effective area. When an operation is performed for recording in another recording mode, the display is switched to a through image for the other recording mode.

Regarding how a through image is displayed by the imaging device, various techniques have been disclosed. For example, there has been one conventional imaging device that simultaneously displays, in respective regions of the same size, an image of image data which is output from the imaging element and an image of trimmed image data generated from the output image data.

It is supposed that, while the conventional imaging device as described above displays a through image for one of a plurality of recording modes whose respective effective areas are different from each other, a user is to record an image in another recording mode. In this case, it is necessary for the user to perform a burdensome operation of switching the displayed through image and confirming the range of the image to be recorded. Depending on the case, it is further necessary to perform a burdensome operation of adjusting the capturing range of the image sensor as required.

Regarding the above-described conventional imaging device, a user can visually recognize both an image to be recorded and its original image.

The conventional imaging device as described above, however, could not have eliminated the need for the burdensome operation which has to be performed for recording images in one or more modes selected from a plurality of modes, which are different from each other in terms of the effective area defined relative to the light receiving area of the image sensor.

### SUMMARY OF THE INVENTION

An imaging device according to the present invention includes an imaging unit, and a display unit which displays an image captured by the imaging unit. The display unit successively displays each of two or more images of images captured by the imaging unit and images cut out in one or more modes from the captured images.

Preferably, the imaging device further includes a recording unit which records an image captured by the imaging unit in a recording medium. The recording unit records in the recording medium one or more images of the images captured by the imaging unit and the images cut out in one or more modes from the captured images.

Preferably, the two or more images are images that are different from each other in at least one of aspect ratio, resolution, frame rate, and scanning method.

Preferably, the imaging unit includes a first imaging unit and a second imaging unit. The two or more images include a moving image captured by the first imaging unit and a still image captured by the second imaging unit.

Preferably, the two or more images include a moving image and a still image.

Preferably, the two or more images include moving images that are different from each other in at least one of aspect ratio, resolution, frame rate, and scanning method.

Preferably, the two or more images include still images that are different from each other in at least one of aspect ratio and resolution.

A control method for an imaging device according to the present invention is a control method for an imaging device including an imaging unit. The method includes the steps of providing images captured by the imaging unit and successively displaying, by the imaging device, each of two or more images of images captured by the imaging unit and images cut out in one or more modes from the captured images.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are each an external view of an imaging device of one embodiment of the present invention.

FIG. 2 is a block diagram showing an electrical schematic configuration of the imaging device in FIG. 1.

FIG. 3 is a diagram for illustrating a plurality of display regions defined on an LCD (Liquid Crystal Display) of the imaging device in FIG. 1.

FIGS. 4A and 4B are diagrams for illustrating a plurality of modes in which an imaging signal is cut out from a light receiving area of a CCD in the imaging device of FIG. 1.

FIG. 5 is a diagram for illustrating a display manner of the LCD in a shooting standby state of the imaging device of FIG. 1.

FIG. 6 is a flowchart of a shooting process executed in the imaging device of FIG. 1.

FIG. 7 is a diagram showing an example of the display manner of the LCD immediately after a still image is recorded in the imaging device of FIG. 1.

FIG. 8 is a diagram showing an example of the display manner of the LCD during a recording period of a moving image in the imaging device of FIG. 1.

FIG. 9 is a diagram showing an example of the display manner of the LCD during a recording period of a moving image in a first modification of the imaging device in FIG. 1.

FIG. 10 is a diagram showing an example of the display manner of the LCD during a recording period of a moving image in a second modification of the imaging device in FIG. 1.

FIG. 11 is a diagram showing an example of the display manner of the LCD during a recording period of a moving image in a third modification of the imaging device in FIG. 1.

FIG. 12 is a block diagram showing an electrical schematic configuration of an imaging device of another embodiment of the present invention.

FIG. 13A is a diagram for illustrating a manner of reading signal charge of moving images of the VGA size.

FIG. 13B is a diagram for illustrating a manner of reading signal charge of moving images of the UXGA size.

### DESCRIPTION OF THE PREFERRED EMBODIMENTS

In the following, embodiments of the present invention will be described in detail with reference to the drawings. In the drawings, the same or corresponding components are denoted by the same reference characters, and a description thereof will not be repeated.

### First Embodiment

Overall Configuration of Imaging Device

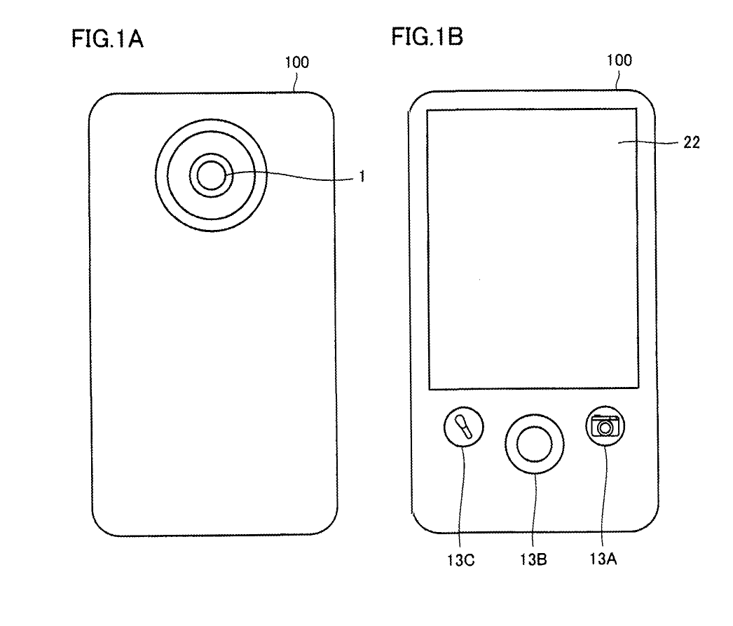

FIGS. 1A and 1B are each an external view of an imaging device 100 of a first embodiment of the present invention. Here, FIG. 1A is an external view of imaging device 100 as seen from the side where a shooting lens is provided, and FIG. 1B is an external view of imaging device 100 as seen from the side where an LCD, which is an example of the display, is provided. Imaging device 100 may be a digital movie camera or a mobile communication terminal device having the video camera capability.

Imaging device 100 may be oriented so that shooting lens 1 faces a photographic subject while LCD 22 faces a user, to thereby enable the user to utilize LCD 22 as a viewfinder of an imaging unit including shooting lens 1.

Further, imaging device 100 is equipped with a moving image shooting button 13A for starting or stopping an operation of shooting a moving image, a release button 13B for starting an operation of shooting a still image, and an audio recording button 13C for starting or stopping an operation of recording sound.

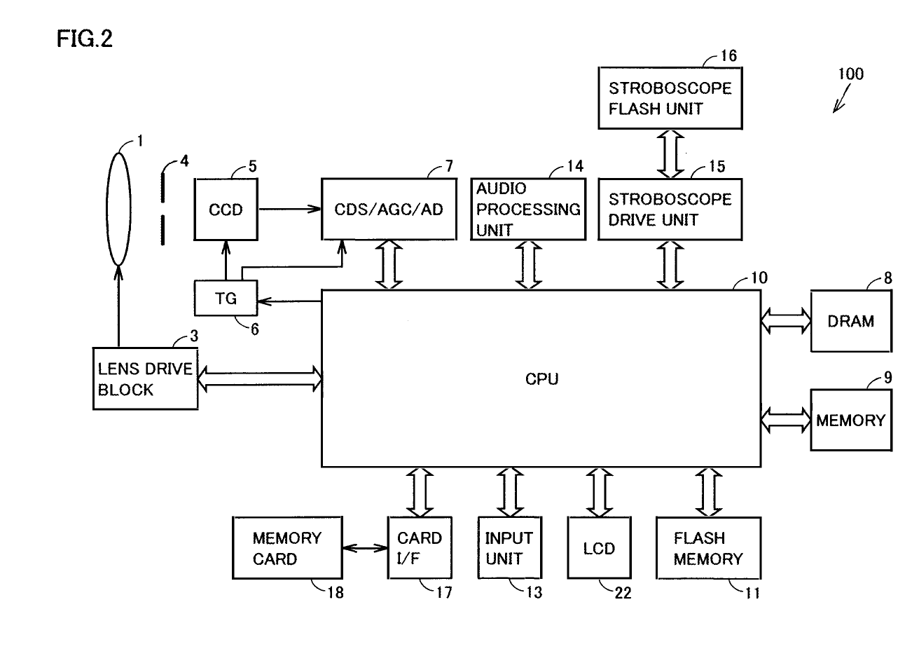

FIG. 2 is a block diagram showing an electrical schematic configuration of imaging device 100.

Imaging device 100 includes shooting lens 1, a lens drive block 3, a diaphragm shutter 4, a CCD 5, a TG (Timing Generator) 6, a unit circuit 7, a DRAM (Dynamic Random Access Memory) 8, a memory 9, a CPU (Central Processing Unit) 10, a flash memory 11, LCD 22, an input unit 13, an audio processing unit 14, a stroboscope drive unit 15, a stroboscope flash unit 16, and a card I/F (interface) 17. To card I/F 17, a memory card 18 is connected that is removably inserted in a card slot (not shown) of the body of imaging device 100.

Shooting lens 1 includes a focus lens and a zoom lens (not shown), and lens drive block 3 is connected to shooting lens 1. Lens drive block 3 is constituted of motors for driving the focus lens and the zoom lens (not shown) respectively in the direction of the optical axis, and a focus driver and a zoom driver for driving the focus motor and the zoom motor respectively in the direction of the optical axis in accordance with a control signal from CPU 10.

Diaphragm shutter 4 includes a drive circuit (not shown). Following a control signal transmitted from CPU 10, this drive circuit causes the diaphragm shutter to operate. This diaphragm shutter functions as a diaphragm and as a shutter.

The diaphragm is a mechanism of controlling the amount of light that enters from the shooting lens, and the shutter is a mechanism of controlling the period of time for which CCD 5 is exposed to light. The period of time for which CCD 5 is exposed to light varies depending on the speed of opening and closing the shutter (shutter speed). The exposure can be determined by the aperture of the diaphragm and the shutter speed.

CCD 5 converts into an electrical signal the light of a photographic subject projected through shooting lens 1 and diaphragm shutter 4, and outputs the electrical signal as an imaging signal to unit circuit 7. CCD 5 is also driven, following a timing signal of a predetermined frequency generated by TG 6. To TG 6, unit circuit 7 is connected.

Unit circuit 7 is constituted of a CDS (Correlated Double Sampling) circuit performing correlated double sampling on the imaging signal that is output from CCD 5 and holding the sampled imaging signal, an AGC (Automatic Gain Control) circuit performing automatic gain control on the sampled imaging signal, and an A/D (Analog/Digital) converter converting into a digital signal the analog imaging signal having undergone automatic gain control. The imaging signal of CCD 5 is transmitted in the form of the digital signal through unit circuit 7 to CPU 10.

CPU 10 has the capabilities of performing, on image data transmitted from unit circuit 7, image processing (such as pixel interpolation, y correction, generation of a brightness/color difference signal, white balance processing, and exposure compensation), and compression and expansion (compression and expansion in the JPEG (Joint Photographic Experts Group) format and the MPEG (Moving Picture Experts Group) format, for example), and also controls each component of imaging device 100. CPU 10 is implemented for example by a one-chip microcomputer.

DRAM 8 is used as a buffer memory for temporarily storing image data captured by CCD 5 and thereafter sent to CPU 10, and also used as a working memory of CPU 10. This DRAM 8 includes four storage areas, namely a captured image storage area, a trimmed image storage area, a composite image storage area, and a trimming information storage area.

In memory 9, a program that is necessary for CPU 10 to control each component of imaging device 100, as well as data that is necessary for controlling each component (default value of information about trimming range) are recorded, and CPU 10 performs processing following this program.

Input unit 13 includes a moving image shooting button 13A, a release button 13B, and an audio recording button 13C, and outputs to CPU 10 an operation signal according to a user's operation. Input unit 13 is not limited to hardware keys such as moving image shooting button 13A, but may include a software key displayed on LCD 22 in such a case where an input device like touch sensor is attached on LCD 22, or may be constituted of software keys only.

Flash memory 11 and memory card 18 are each a recording medium for storing image data for example captured by CCD 5. In connection with the present embodiment, a description concerning writing (recording) of image data will be given by solely using flash memory 11. The user, however, may operate input unit 13 to select whether to record image data in flash memory 11 or memory card 18.

LCD 22 includes a color LCD and a drive circuit for the color LCD. In a shooting standby state, LCD 22 displays, in the faun of a through image, a photographic subject captured by CCD 5. When a recorded image is to be reproduced, the recorded image is read from flash memory 11 or memory card 18 and expanded to be displayed. Here, “through image” is an image captured by CCD 5 and displayed in such a manner that images are successively captured by CCD 5 and switched successively to appear on LCD 22.

Audio processing unit 14 includes an internal microphone, an amplifier, an A/D converter, a D/A converter, and an internal speaker, for example. When an image with sound is to be shot, the sound that is input to the internal microphone is converted into a digital signal and transmitted to CPU 10. CPU 10 causes the transmitted audio data to be stored successively in the buffer memory (DRAM 8), and recorded in flash memory 11 or memory card 18 together with the image data captured by CCD 5.

When an image with sound is to be reproduced, audio processing unit 14 emits, from the internal speaker, sound for example based on audio data that accompanies each image data.

Stroboscope drive unit 15 follows a control signal from CPU 10 to drive stroboscope flash unit 16 so that it generates flashlight, and stroboscope flash unit 16 emits flashlight. Here, CPU 10 determines whether a scene to be shot is dark or not, based on an output signal of CCD 5 or by means of a photometer circuit (not shown). In the case where CPU 10 determines that the scene to be shot is dark, it transmits a control signal to stroboscope drive unit 15 at the time when it is determined that the scene is to be shot (when the shutter button is pressed).

Screen Display of Imaging Device

In imaging device 100 of the present embodiment, image data captured by CCD 5 can be recorded in a plurality of modes by CPU 10 in a recording medium such as flash memory 11.

Here, a plurality of modes include for example moving image and still image.

In connection with the present embodiment, a case will be described where an image which is cut out from an image captured by CCD 5 in the AVI (Audio Video Interleave) format, which is an example format of moving images, has an aspect ratio of 16:9. Further, as an example of still images recorded in the present embodiment, a still image file having an aspect ratio of 4:3 will be illustrated.

When imaging device 100 is in the shooting standby state, LCD 22 displays through images for a plurality of modes respectively that can be recorded.

The through image is displayed, for example, in such a manner that CPU 10 causes DRAM 8 to temporarily store an image captured by CCD 5, and reads from DRAM 8 the image in an appropriate range to cause LCD 22 to display the image.

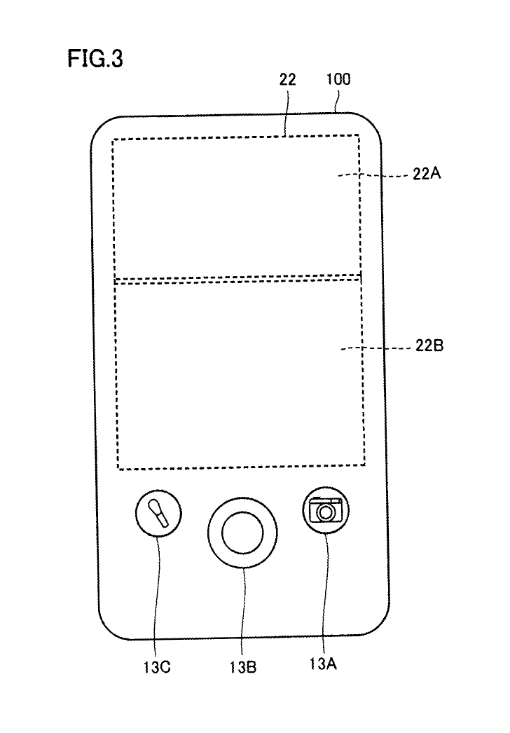

Thus, on LCD 22 as shown in FIG. 3, regions are defined for displaying the through images for respective modes of a plurality of modes. Specifically, as shown in FIG. 3, a first display region 22A and a second display region 22B are defined on LCD 22. First display region 22A is located above second display region 22B.

First display region 22A is adapted to moving images of the AVI format. Second display region 22B is adapted to the above-described still images. Namely, the aspect ratio of first display region 22A is 16:9 and the aspect ratio of second display region 22B is 4:3.

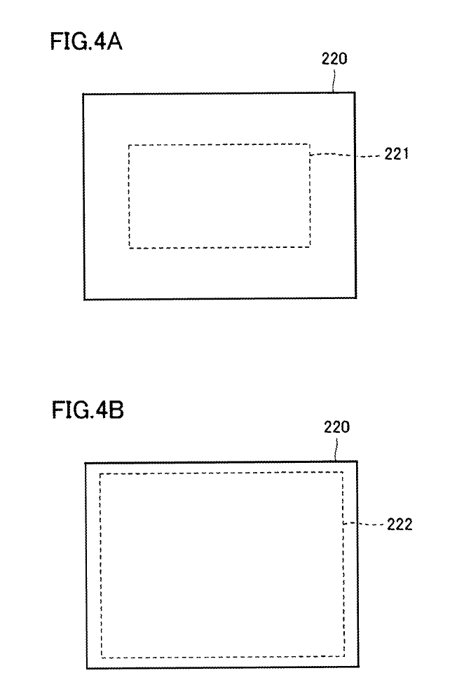

When imaging device 100 is in the shooting standby state, a through image for a moving image is displayed in first display region 22A, and a through image for a still image is displayed in second display region 22B. Here, a description will be given of how these through images are generated, with reference to FIGS. 4A and 4B.

In FIGS. 4A and 4B, a region 220 is a schematic representation of the light receiving area of CCD 5. CPU 10 cuts out, from the light receiving area represented by region 220, an imaging signal of a region 221 shown in FIG. 4A to display a through image for a moving image and record it as a moving image. Further, CPU 10 cuts out, from region 220, an imaging signal of a region 222 shown in FIG. 4B to display a through image for a still image and record it as a still image. The aspect ratio of region 221 in FIG. 4A conforms to the AVI format, namely 16:9. In contrast, the aspect ratio of region 222 in FIG. 4B conforms to the above-described aspect ratio of still images, namely 4:3.

CPU 10 then causes a through image for a moving image to be displayed in first display region 22A in FIG. 3, and a through image for a still image to be displayed in second display region 22B in FIG. 3.

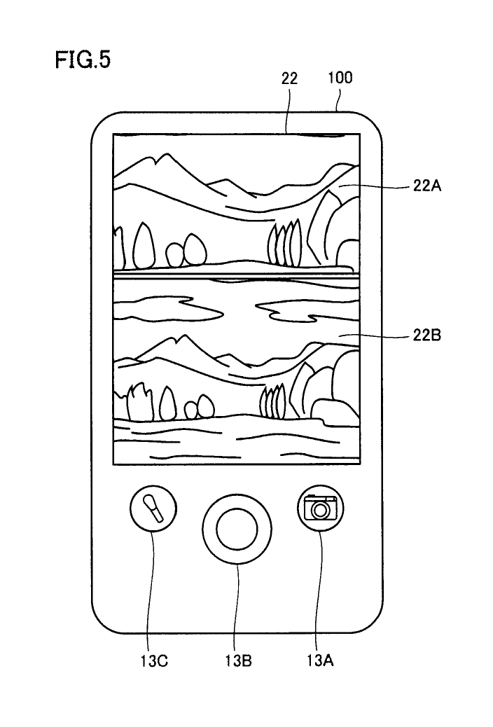

FIG. 5 is a diagram schematically showing a state where a through image for a moving image is displayed in first display region 22A and a through image for a still image is displayed in second display region 22B.

Referring to FIG. 5, the through image for a moving image displayed in first display region 22A and the through image for a still image displayed in second display region 22B have been cut out from the same original image. The through images in respective regions may not be cut out from the same original image. Namely, the through image for a moving image and the through image for a still image may be updated for example at different time intervals. Specifically, the through image for a moving image may be updated for example at intervals of 1/15 second, and the through image for a still image may be updated for example at intervals of 1/10 second.

A user of imaging device 100 can visually recognize the displayed contents of LCD 22 as shown in FIG. 5 to thereby visually recognize the through image for a moving image and the through image for a still image at the same time. Namely, one can visually recognize, on LCD 22, images of a plurality of modes that can be recorded in a recording medium such as flash memory 11, specifically a plurality of images having been cut out in different modes from the light receiving area of CCD 5. Accordingly, regardless of whether recording of moving images is to be started or recording of still images is to be started, a burdensome operation is unnecessary such as switching of the display for causing LCD 22 to display a through image of an image to be recorded.

When imaging device 100 is in the state shown in FIG. 5 and moving image shooting button 13A is operated, recording of a moving image is started. Recording of the moving image is continued until moving image shooting button 13A is operated again.

Further, when release button 13B is operated while the imaging device is in the state shown in FIG. 5, imaging device 100 starts recording a still image.

On LCD 22, the region except for first display region 22A and second image region 22B is a background displayed for example in black.

Shooting Process

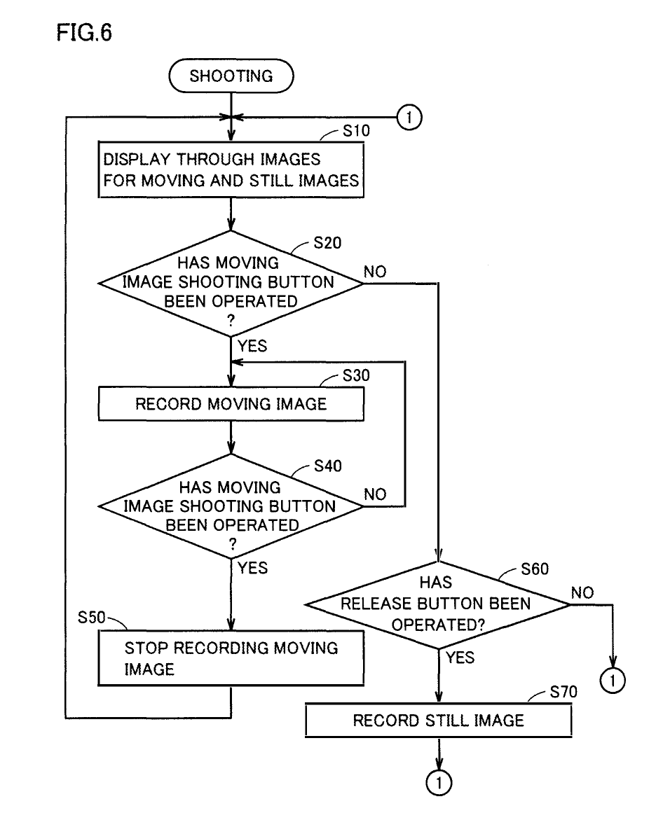

In the following, a description will be given of details of a process executed by CPU 10 when imaging device 100 shoots (records) a moving image and/or a still image, with reference to FIG. 6 showing a flowchart of this process. The process is started in response to an operation for shifting imaging device 100 to a camera mode. An example of such an operation may be an operation of pressing moving image shooting button 13A or release button 13B.

Referring to FIG. 6, in response to shift of imaging device 100 to the camera mode, CPU 10 first causes, in step S10, LCD 22 to display a through image for a moving image and a through image for a still image as shown in FIG. 5, and proceeds to step S20.

In step S20, CPU 10 determines whether or not moving image shooting button 13A has been operated. When CPU 10 determines that the button has been operated, it proceeds to step S30. When CPU 10 determines that the button has not been operated, it proceeds to step S60.

In step S60, CPU 10 determines whether or not release button 13B has been operated. When CPU 10 determines that the button has been operated, it proceeds to step S70. When CPU 10 determines that the button has not been operated, it returns to step S10.

In step S70, CPU 10 causes an image captured by CCD 5 to be recorded as a still image in a recording medium such as flash memory 11, and returns to step S10.

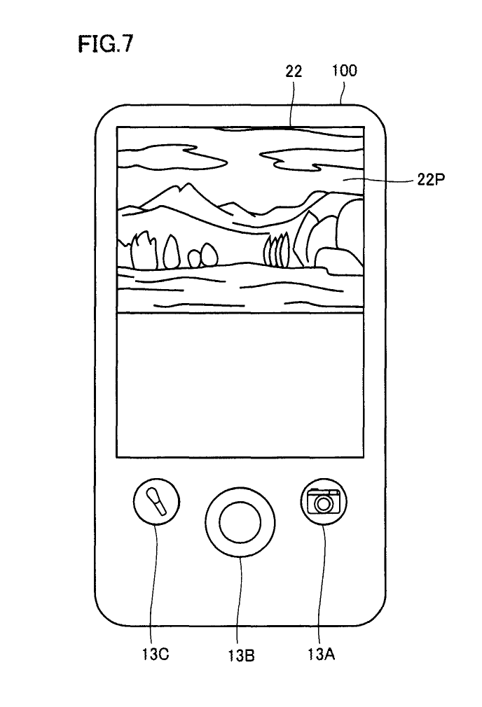

When the still image is recorded in step S70, it is preferable that the recorded still image is displayed on LCD 22 for a certain period of time. FIG. 7 is a diagram showing an example of the display manner of LCD 22 immediately after the still image is recorded.

Referring to FIG. 7, LCD 22 displays only the still image in a region 22P. Thus, a user can confirm the still image recorded in the recording medium. After CPU 10 causes LCD 22 to display the still image recorded in step S70 for a certain period of time (three seconds for example) as shown in FIG. 7, CPU 10 causes LCD 22 to display the through image for a moving image and the through image for a still image as shown in FIG. 5 (step S10).

In step S30, CPU 10 starts recording the image as a moving image that has been captured by CCD 5. At this time, CPU 10 repeats an operation of repeatedly reading signal charge from a part (region 221 in FIG. 4A) of the image of CCD 5 at certain time intervals and recording it in the above-described recording medium.

Then, in step S40, CPU 10 determines whether or not moving image shooting button 13A has been operated. When CPU 10 determines that moving image shooting button 13A has not been operated, it returns to step S30. In contrast, when CPU 10 determines in step S40 that moving image shooting button 13A has been operated, it proceeds to step S50. In step S50, CPU 10 stops recording of the moving image, and returns to step S10.

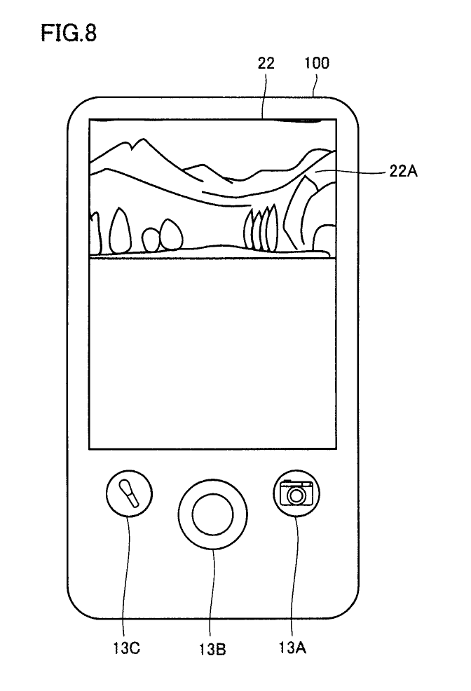

During the period in which CPU 10 repeats the moving image recording operation in step S30, it is preferable to cause LCD 22 to display only the through image for the moving image as shown in FIG. 8.

### First Modification

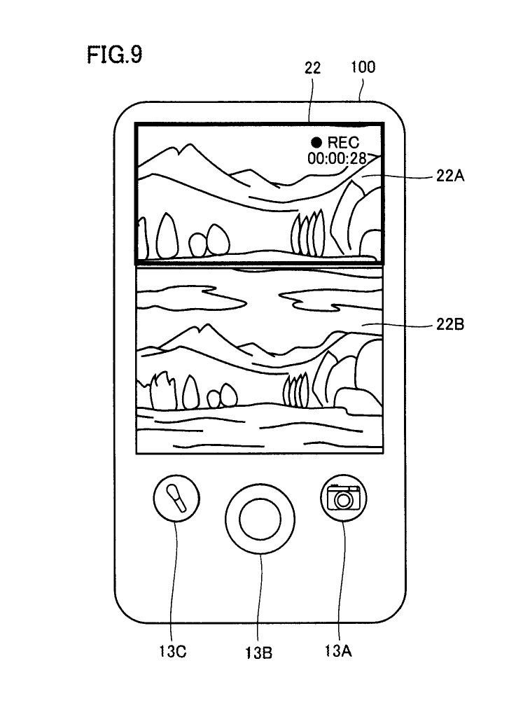

In the present embodiment described above, during the period in which a moving image is recorded in the shooting process explained above with reference to FIG. 6, only the through image for the moving image is displayed on LCD 22 (see FIG. 8). Here, during the period in which a moving image is recorded, the LCD may also display a through image for a still image together with the through image for the moving image, as explained above with reference to FIG. 5. Here, it is preferable to display the information that, of the moving image and the still image for which respective through images are displayed on LCD 22, the moving image is being recorded. For example, as shown in FIG. 9, while a moving image is recorded, a through image for the moving image is displayed in first display region 22A of LCD 22, and a through image for a still image is displayed in second display region 22B thereof. Further, emphasis is added to first display region 22A (the bold line of the perimeter) for indicating that the moving image is being recorded. Furthermore, information that recording is in process (“•REC”) as well as recording time (“00:00:28”) are displayed.

The display is given as described above, and therefore, a user of imaging device 100 who is to switch the moving image which is being recorded to a still image which is to be recorded can avoid the need for a burdensome operation such as switching of the through image, since the through image for the still image is displayed in display region 22B.

### Second Modification

In the present embodiment as described above, when an image is to be recorded, the display region of LCD 22 is divided into a plurality of regions and a plurality of through images that have been differently cut out from an image captured by CCD 5 are displayed in these regions respectively. Namely, in a plurality of display regions of LCD 22, respective images cut out in different modes from each other are each displayed successively. Then, of the multiple through images, a through image which has not been selected for being recorded in the recording medium disappears from LCD 22 and is not displayed during the period in which the selected image is being recorded (or immediately after it is recorded) as shown in FIG. 7 or 8.

In the present modification, the display region in which a through image of a mode that has not been selected for being recorded, among a plurality of modes whose through images are displayed on LCD 22 in the shooting standby state, is used as a working area for the image to be recorded. A specific example of working is selection of a zoom area in the image to be recorded.

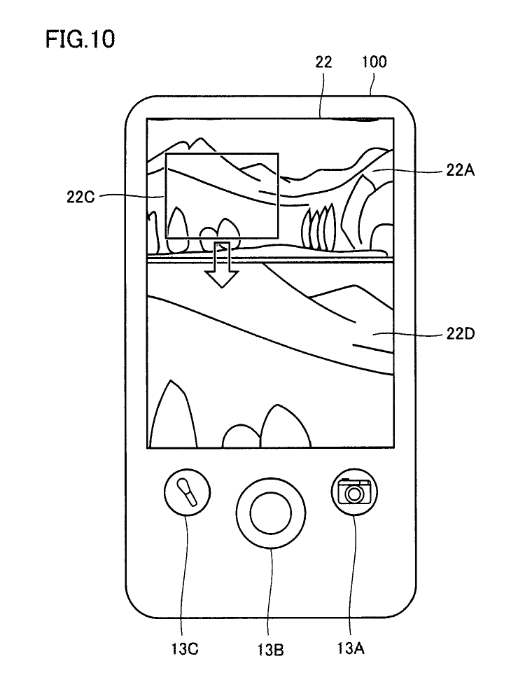

In step S30 of FIG. 6, recording of a moving image is started. Then, as shown in FIG. 8, the LCD first displays a through image for the moving image in first display region 22A. When an operation for recording the image in an enlarged form is performed (zoom operation) while the moving image is being recorded, LCD 22 shows a frame 22C defining a local region overlapping the through image for the moving image being recorded, as shown in FIG. 10. Then, in the region (display region 22D) corresponding to second display region 22B on LCD 22, the image within frame 22C is displayed in the enlarged form.

When an operation is performed on input unit 13 for changing the position of frame 22C in first display region 22A, CPU 10 changes the display position of frame 22C in first display region 22A, and changes the position where a partial image is cut out from the image displayed in display region 22D.

Then, when an operation is performed on input unit 13 for confirming a change of the enlargement ratio of the image to be recorded, the moving image to be recorded in the recording medium such as flash memory 11 is recorded at the changed enlargement ratio.

When the moving image is to be recorded in the AVI format, the aspect ratio of display region 22D is preferably 16:9 which conforms to the AVI format.

### Third Modification

In the above-described second modification, through images are displayed in the shooting standby state, and the region in which displayed the through image of the mode which has not been selected for recording is used as a region in which a zoom image is displayed.

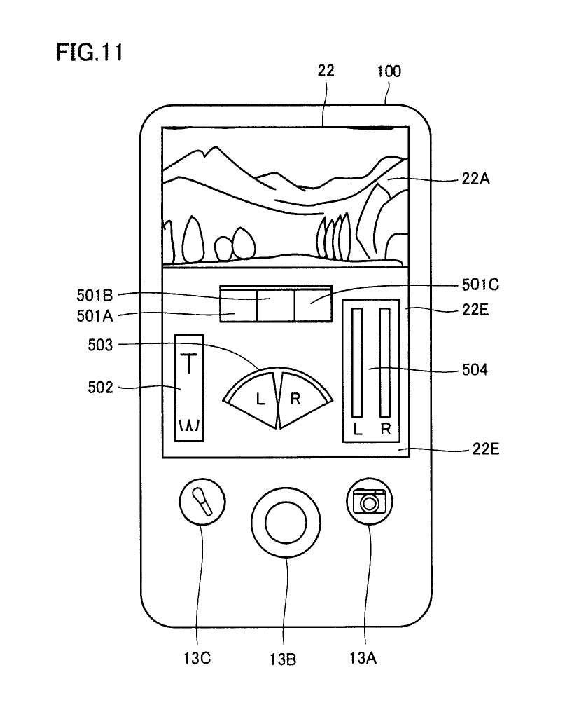

In the present modification, display is given in this region for accepting input of information about setting of a recording mode for an image which is being recorded. FIG. 11 is a diagram showing an example of the display manner of LCD 22 during the period in which a moving image is being recorded in the present modification.

Referring to FIG. 11, after recording of a moving image is started in step S30 of FIG. 6, a predetermined operation is performed on input unit 13. In response to this, a control screen is displayed in a region (display region 22E) other than first display region 22A in which a through image for the moving image is displayed on LCD 22.

In the control screen, a level meter 504 indicating respective levels on the right side and the left side of the sound recorded together with the image, a zoom adjustment button 502 operated for adjusting digital zoom, a sound zoom button 503 for adjusting the sound zoom, an adjustment button 501A for adjusting exposure compensation, an icon 501B for adjusting the white balance, and an icon 501C operated to select the photometric method are displayed. The various buttons and icons displayed in display region 22E may be operated by means of a pointer displayed in display region 22E by an appropriate operation of input unit 13. Alternatively, in the case where a touch sensor is provided on LCD 22 and LCD 22 functions as a touch panel, the buttons may be operated by being touched.

### Second Embodiment

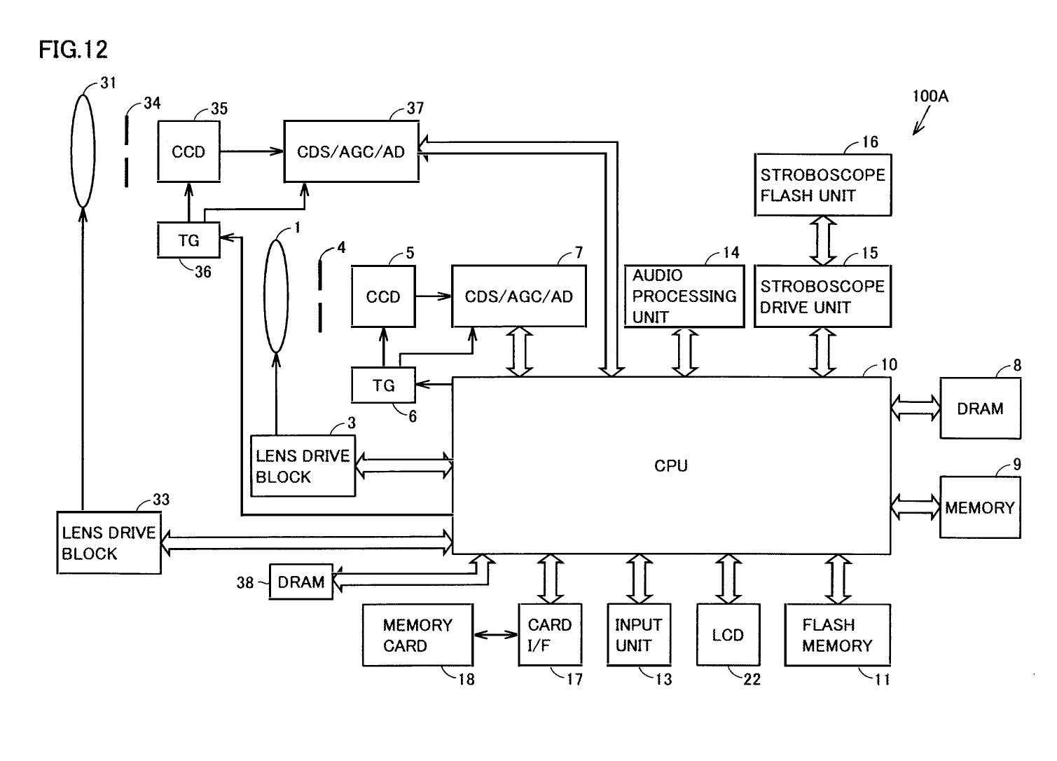

FIG. 12 is a block diagram showing an electrical schematic configuration of an imaging device 100A in a second embodiment of the present invention. Imaging device 100A is a so-called twin-lens imaging device having two imaging units each including a lens and a CCD. Imaging device 100A is used for example for shooting 3D images.

Referring to FIG. 12, in contrast to imaging device 100 described with reference to FIG. 2, imaging device 100A further includes a shooting lens 31, a lens drive block 33, a diaphragm shutter 34, a CCD 35, a TG 36, a unit circuit 37, and a DRAM 38. Lens drive block 33 is constituted of motors for driving a focus lens and a zoom lens (not shown) respectively in the direction of the optical axis, and a focus driver and a zoom driver for driving the focus motor and the zoom motor respectively in the direction of the optical axis in accordance with a control signal from CPU 10. In the present embodiment, lens drive block 3 drives shooting lens 1 and lens drive block 33 drives shooting lens 31.

Diaphragm shutter 34 includes a drive circuit (not shown). Following a control signal transmitted from CPU 10, this drive circuit causes diaphragm shutter 34 to operate. Diaphragm shutter 34 has a mechanism (diaphragm) of controlling the amount of light that enters from shooting lens 31, and a mechanism of controlling the period of time for which CCD 35 is exposed to light. In this way, the exposure of CCD 35 is controlled.

CCD 35 converts into an electrical signal the light of a photographic subject projected through shooting lens 31 and diaphragm shutter 34, and outputs the electrical signal as an imaging signal to unit circuit 37. CCD 35 is also driven, following a timing signal of a predetermined frequency generated by TG 36. To TG 36, unit circuit 37 is connected.

Unit circuit 37, like unit circuit 7, is constituted of a CDS circuit performing correlated double sampling on the imaging signal that is output from CCD 35 and holding the sampled imaging signal, an AGC circuit performing automatic gain control on the sampled imaging signal, and an A/D converter converting into a digital signal the analog imaging signal having undergone automatic gain control. The imaging signal of CCD 35 is transmitted in the form of the digital signal through unit circuit 37 to CPU 10.

CPU 10 performs image processing on the image data transmitted from unit circuit 37, in a similar manner to image processing on the image data transmitted from unit circuit 7. CPU 10 further performs compression and expansion on the image data.

DRAM 38 is used as a buffer memory for temporarily storing images captured by CCD 35 and thereafter sent to CPU 10, and also used as a working memory of CPU 10.

In imaging device 100A of the present embodiment, CPU 10 can generate 3D images using the imaging signal of CCD 5 and the imaging signal of CCD 35. Namely, shooting lens 1 and shooting lens 31 are arranged in such a manner that enables a single 3D image to be generated by respective imaging signals of CCD 5 and CCD 35 in imaging device 100A.

Further, CPU 10 can use, for recording of an image, respective imaging signals of CCD 5 and CCD 35 independently of each other. Namely, CPU 10 can use the imaging signal of CCD 5 for recording a moving image and use the imaging signal of CCD 35 for recording a still image, for example.

Accordingly, in the shooting process explained above with reference to FIG. 6, CPU 10 of the present embodiment causes in step S10 first display region 22A to display a through image for a moving image and second display region 22B to display a through image for a still image as explained with reference to FIG. 5. The through image displayed in first display region 22A is an image based on an image signal of CCD 5, and is an image generated by reading an appropriate range from an image which is captured by CCD 5 and temporarily stored in DRAM 8. The through image displayed in second display region 22B is an image based on an imaging signal of CCD 35, and is an image generated by reading an appropriate range from an image captured by CCD 35 and temporarily stored in DRAM 38.

In the present embodiment described above, imaging device 100A is provided with a plurality of CCDs and image data captured by respective CCDs may be recorded in different modes (moving image and still image for example) from each other in a recording medium such as flash memory 11.

In imaging device 100A of the present embodiment, LCD 22 displays respective through images for these images recorded in a plurality of modes.

In the present embodiment, as long as a plurality of CCDs are provided in imaging device 100A, they may not necessarily be used for shooting 3D images, and may not necessarily be arranged to be adapted to shooting of 3D images.

### Other Modifications

Regarding imaging device 100 and imaging device 100A described above, through images corresponding to a plurality of modes are displayed in the recording standby state, and an image of a mode specified among these modes is recorded in a recording medium such as flash memory 11.

Here, images of “a plurality of modes” for which through images are displayed in the recording standby state are not limited to images each cut out with a predetermined size from an image captured by CCD 5, but may include images corresponding to all imaging signals that are output from CCD 5. Namely, an image captured by CCD 5 may be directly displayed as a through image or recorded in flash memory 11 without being cut out.

Further, in the present embodiments, the imaging unit is not limited to the CCD, and may be of other types such as CMOS (Complementary Metal Oxide Semiconductor) sensor or the like.

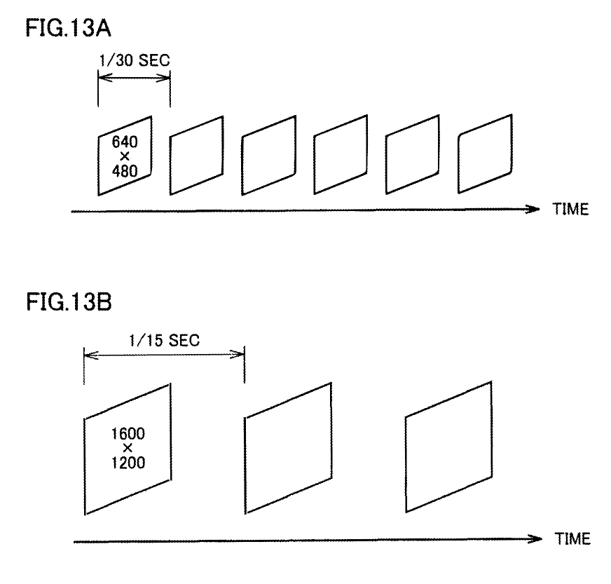

The combination of a plurality of modes is not particularly limited to the above-described combination of moving image and still image. For example, the combination may include moving images of respective data formats different from each other. Specifically, one moving image may be of the VGA size and the other moving image may be of the UXGA size. As to the former moving image, as shown in FIG. 13A, from partial pixels of CCD 5, signal charge is repeatedly read at intervals of 1/30 second and the moving image is captured at a frame rate of 30 fps. The number of pixels (resolution) of the image data in each frame constituting the moving image is the VGA size (640×480). When the latter moving image is shot, from partial pixels or all pixels of CCD 5 (or CCD 35), signal charge is repeatedly read at intervals of 1/15 second, and the moving image is captured at a frame rate of 15 fps. As shown in FIG. 13B, the number of pixels of image data in each frame constituting the moving image is the UXGA size (1600×1200).

Further, the combination may include moving images that are different from each other in terms of at least one of the aspect ratio, the resolution, the frame rate, and the scanning method (such as interlace, progressive).

Further, the above-described plurality of modes may be still images having respective numbers of pixels different from each other.

Namely, regarding the number of pixels of a still image to be recorded in imaging device 100 and imaging device 100A, two or more resolutions can be selected from two or more different resolutions (240×320, 240×400, 640×480, 1280×960, 1600×1200 for example). In the shooting standby state, respective through images for the selected two or more resolutions are displayed on LCD 22. Then, a user may appropriately operate input unit 13 to select a mode to be recorded from a plurality of displayed through images, to thereby enable a still image to be recorded with the selected resolution, in a recording medium such as flash memory 11.

Further, they may be still images having respective aspect ratios different from each other.

Accordingly, a plurality of through images can visually be recognized at the same time, and the number of pixels to be recorded in a recording medium can be selected. Thus, when the number of pixels to be recorded is selected from a plurality of different numbers of pixels, the need can be avoided for a burdensome operation of selecting a through image to be displayed on LCD 22 in the standby state.

Further, in the above-described embodiments each, moving image shooting button 13A, release button 13B, and audio recording button 13C are arranged as hardware buttons on imaging device 100 (or imaging device 100A). The positions where they are arranged are not limited to those shown for example in FIG. 1B. The buttons may be implemented as software buttons displayed on LCD 22.

In accordance with the present embodiments, the imaging device successively displays each of two or more images out of images captured by the imaging means, or images cut out in one or more modes from the captured images. Namely, the imaging device displays respective through images for the above-described two or more images.

Thus, when the imaging device is used to record images of one or more modes selected from a plurality of modes whose effective areas relative to the light receiving area of the image sensor are different from each other, through images of two or more modes can be seen. Therefore, the need for a burdensome operation performed by a user for switching the through image for example can be avoided.

Accordingly, when a user of the imaging device is to record an image by selecting one or more modes from a plurality of modes whose respective areas relative to the light receiving area of the image sensor are different from each other, it is not necessary for the user to perform a burdensome operation.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An imaging device comprising:
an imaging unit; and
a display unit which displays an image captured by said imaging unit,
said display unit successively displaying each of two or more images of images captured by said imaging unit and images cut out in one or more modes from the captured images.

2. The imaging device according to claim 1, further comprising a recording unit which records an image captured by said imaging unit in a recording medium, wherein
said recording unit records in said recording medium one or more images of the images captured by said imaging unit and the images cut out in one or more modes from the captured images.

3. The imaging device according to claim 1, wherein
said two or more images are images that are different from each other in at least one of aspect ratio, resolution, frame rate, and scanning method.

4. The imaging device according to claim 1, wherein
said imaging unit includes a first imaging unit and a second imaging unit, and
said two or more images include a moving image captured by said first imaging unit and a still image captured by said second imaging unit.

5. The imaging device according to claim 1, wherein
said two or more images include a moving image and a still image.

6. The imaging device according to claim 1, wherein
said two or more images include moving images that are different from each other in at least one of aspect ratio, resolution, frame rate, and scanning method.

7. The imaging device according to claim 1, wherein
said two or more images include still images that are different from each other in at least one of aspect ratio and resolution.

8. A control method for an imaging device including an imaging unit, comprising the steps of:
providing images captured by said imaging unit; and
successively displaying, by said imaging device, each of two or more images of images captured by said imaging unit and images cut out in one or more modes from the captured images.
